(19) United States
(12) Patent Application Publication
(10) Pub. No.: US 2008/0185194 A1
(43) Pub. Date: Aug. 7, 2008

(54) Hybrid Vehicle With Engine Power Cylinder Deactivation

(75) Inventor: Thomas Leone, Ypsilanti, MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/670,573

(22) Filed: Feb. 2, 2007

(51) Int. Cl. B60K 6/00

(52) U.S. Cl. 180/65.2; 701/102; 903/902

(57) ABSTRACT

A hybrid vehicle includes a reciprocating internal combustion engine having intake and exhaust poppet valves which are controlled so as to minimize the amount of power required to motor the engine during regenerative braking, so as to maximize energy stored within an energy storage device recharged by a rotating reversible machine operatively connected with the engine, the vehicle's road wheels, and the energy storage device.

### BACKGROUND OF THE INVENTION

1. Field of the Invention

The present invention relates to a hybrid vehicle having an internal combustion engine, a rotating reversible machine coupled to the engine for selectively providing both power to road wheels and regenerative braking capability enhanced by operating the engine cylinder valves so as to minimize the motoring horsepower of the engine during regenerative braking.

2. Disclosure Information

Hybrid vehicles have taken many forms. A common form of the so-called “mild” hybrid includes an internal combustion engine driving road wheels through a transmission. With a mild hybrid, a rotating reversible machine, such as an electric motor/generator or hydraulic pump/motor, is coupled to the engine for rotation with the engine's crankshaft. Accordingly, the reversible machine rotates whenever the engine is rotating. Because the engine rotates in synchronicity with the reversible machine, regenerative braking of the vehicle requires not only that the rotating machine be motored by the vehicle road wheels, but also that the engine be motored by the road wheels during regenerative braking. This is an undesirable situation from the standpoint of maximizing regenerative capability, because the power absorbed by the engine cannot be captured regeneratively.

It would be desirable to minimize the motoring horsepower of an engine in a hybrid vehicle in which the engine and rotating machine are coupled together, so as to maximize regenerative battery, or hydraulic accumulator, charging capability of the vehicle.

### SUMMARY OF THE INVENTION

According to an aspect of the present invention, a hybrid vehicle includes a reciprocating internal combustion engine having a crankshaft and a plurality of power cylinders, with each cylinder having a piston reciprocably housed therein. At least one intake poppet valve and at least one exhaust poppet valve services each engine cylinder. A transmission is coupled to the engine. The transmission is connected to at least one road wheel. A rotating reversible machine, operatively connected with the engine, the transmission, and with an energy storage device such as a traction battery, provides power to the transmission and regeneratively charges the traction battery or other storage device during braking of the vehicle. An engine controller disables at least some of the power cylinders during regenerative braking of the vehicle, by operating at least some of the poppet valves such that the valves open and close at points which are approximately symmetrical about rotational positions of the crankshaft at which the directions of motion of the pistons change.

According to another aspect of the present invention, a hybrid vehicle may include a number of intake port throttles, with one of the throttles being mounted in proximity to each of the intake valves, with the engine controller closing the port throttles of the cylinders being disabled.

According to another aspect of the present invention, an engine controller operates not only exhaust valves, but also intake valves of the cylinders being disabled, such that both the intake valves and the exhaust valves open and close at points which are symmetrical about rotational positions of the crankshaft at which directions of motion of each of the pistons change.

According to another aspect of the present invention, the present poppet valves are operated by a camshaft, with the engine controller further including a cam phaser for powering the camshaft and for adjusting the rotational position of the camshaft with respect to the engine's crankshaft. Multiple camshafts and cam phasers may be used for intake and exhaust valves.

According to another aspect of the present invention, a rotating electrical machine of the present invention is coupled to the vehicle's transmission through the engine at a fixed gear ratio.

According to another aspect of the present invention, a method for operating a reciprocating internal combustion engine in a hybrid vehicle during regenerative braking of the vehicle includes operating a rotating reversible machine, such as an electrical or fluid power machine, coupled to the engine and to at least one road wheel through a transmission, as a power absorber, and operating intake and exhaust poppet valves associated with the power cylinders of the engine such that all said valves open and close at points which are approximately symmetrical about rotational positions of the engine's crankshaft at which the directions of motion of the engine's pistons change, whereby the power required to motor the engine during regenerative braking will be minimized.

According to another aspect of the present invention, a method for motoring a reciprocating internal combustion engine in a hybrid vehicle during regenerative braking, such that power required to motor the engine is reduced and regenerative charging of the traction battery is maximized, includes operating a rotating reversible machine, coupled to at least one road wheel and to the engine, as a generator connected to a storage battery or other energy storage device, while operating intake and exhaust poppet valves associated with the power cylinders of the engine such that the valves open and close at points which are approximately symmetrical about rotational positions of the engine's crankshaft at which the directions of motion of the engine's pistons change.

It is an advantage of a method and system according to the present invention that regenerative capability may be improved for a hybrid vehicle in which the engine and generator/motor are locked together rotationally.

It is yet another advantage of a method and system according to the present invention that increased fuel economy associated with regeneration may be achieved without the need for cylinder valve actuation hardware capable of completely deactivating valves in one or more cylinders of the engine. This advantage results from the present invention because deactivation may be achieved either through a combination of intake port throttling and exhaust valve timing adjustment, or by adjusting the timing of both the intake and exhaust valves. Neither technique requires that the valves be prevented from moving periodically.

Other advantages, as well as features of the present invention, will become apparent to the reader of this specification.

### BRIEF DESCRIPTION OF THE DRAWINGS

FIG. 1 is a schematic representation of a hybrid vehicle according to various aspects of the present invention.

FIG. 2 is a schematic representation of a portion of an internal combustion engine used in the vehicle of FIG. 1.

FIG. 3 is a diagram showing cylinder pressure and crankshaft position with an engine having a cylinder valve control system according to the present invention.

FIG. 4 is a second diagram showing cylinder pressure and crankshaft position of an engine having an alternative timing arrangement according to the present invention.

FIG. 5 is a third diagram showing cylinder pressure and crankshaft position of an engine having an alternative timing arrangement according to the present invention.

### DETAILED DESCRIPTION OF THE PREFERRED EMBODIMENTS

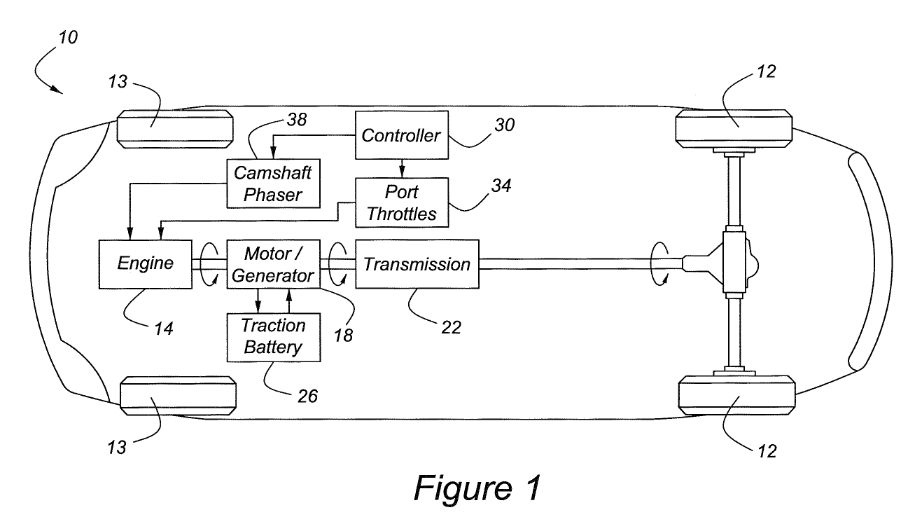

As shown in FIG. 1, vehicle 10 has a number of road wheels 12, which are operated by means of a powertrain including engine 14, motor/generator 18, and transmission 22. Road wheels 13 are unpowered. Engine 14 and motor/generator 18 are coupled together rotationally such that engine 14 generally rotates in unison with motor/generator 18. This arrangement is found in a so-called “mild” hybrid vehicles which offer the advantage of lower initial cost, albeit at the expense of reduced regenerative capability. As noted above, the present invention is intended to increase the regenerative capability which would otherwise be available with vehicle 10.

As its name implies, motor/generator 18 functions not only as a traction motor receiving power from traction battery 26 and powering road wheels 12 through transmission 22; motor/generator 18 also functions as a generator during regenerative braking so that kinetic energy associated with vehicle 10 may be transferred through transmission 22 to motor/generator 18, where the energy is converted to electrical power stored within storage battery 26. Because engine 14 and motor/generator 18 are coupled together, engine 14 also rotates during regenerative braking. As a result, some of the energy which could otherwise be converted to stored energy within traction battery 26 is dissipated by motoring friction within engine 14. As discussed above, motor/generator 18 may be replaced with a hydraulic or pneumatic pump/motor; in either case, traction battery 26 would be replaced by a hydraulic or pneumatic storage tank or accumulator. Thus, as used herein the term “motor/generator” refers to a reversible rotating machine such as an electrical motor/generator, a hydraulic motor/pump or a pneumatic motor/compressor, and the term “traction battery” refers to an energy storage device which could be embodied as an electrical storage battery, or a fluid accumulator, or yet other types of energy storage devices known to those skilled in the art, suggested by this disclosure, and suitable for use as an electrical, hydraulic, or pneumatic energy storage device.

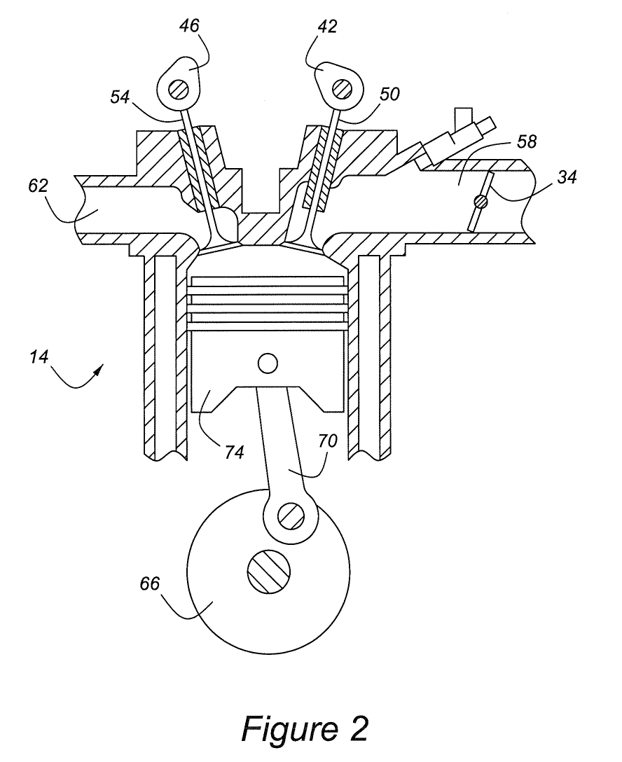

Controller 30 operates camshaft phaser 38 and, optionally, port throttles 34, to maximize regenerative capability of motor/generator 18 by reducing the power required to motor engine 14. The verb “motor” is used herein in the conventional sense that motoring refers to rotation of engine 14 by motor/generator 18, transmission 22, and road wheels 12. Controller 30 operates at least one camshaft phaser 38 which controls the position of at least exhaust camshaft 46 shown in FIG. 2.

FIG. 2 illustrates various details of engine 14. Thus, crankshaft 66 is connected with piston 74 by means of connecting rod 70. Intake valve 50 and exhaust valve 54 control the ingress and egress of air and fuel and exhaust gases, respectively, from the engine's cylinders. Air enters by means of intake port 58 and exhaust gasses leave by means of exhaust port 62. Intake camshaft 42 operates intake valve 50 and exhaust camshaft 46 operates exhaust valve 54. Port throttle 34 is shown as being positioned in intake port 58.

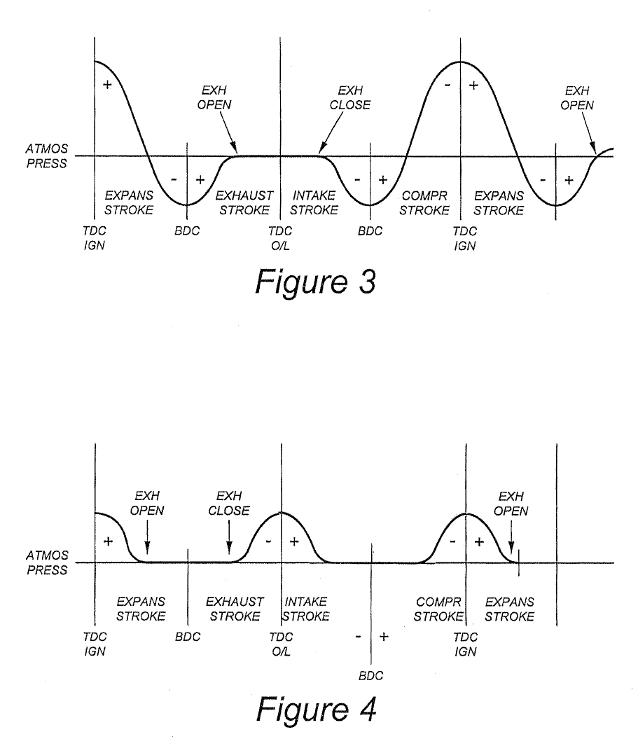

Controller 30 operates camshaft phaser 38 and port throttles 34 during regenerative operation of vehicle 10 by operating exhaust valve 54 in a first instance such that exhaust valve 54 opens and closes at points which are approximately symmetrical about rotational positions of crankshaft 66 at which the direction of motion of piston 74 is changing. This is shown in FIGS. 3 and 4.

In FIG. 3, exhaust valve 54 is shown as opening and closing approximately symmetrically about top dead center (TDC) of the exhaust stroke of a particular cylinder of engine 14. In FIG. 3, pressure within the engine cylinder changes from a negative value at bottom dead center (BDC) on the expansion stroke to roughly atmospheric pressure during the exhaust stroke. As a result, the atmospheric pressure which is reached on the exhaust stroke is maintained through a portion of the intake stroke until the exhaust valve closes. Thereafter the pressure within the cylinder decreases to a sub-atmospheric pressure at BDC of the intake stroke, (because port throttles 34 are closed), and once again increases during the compression stroke to a super-atmospheric value which is then reduced during the expansion stroke following the compression stroke. Because the pressure buildup from sub-atmospheric to atmospheric, which occurs as piston 74 moves from BDC to TDC on the exhaust stroke is reduced to the same sub-atmospheric pressure during the subsequent expansion to BDC on the intake stroke, the net effect is that the work required to compress the gases within the cylinder is extracted during expansion of the intake stroke, and very little energy is dissipated within the engine cylinder.

If camshaft phaser 38 is used only on the exhaust valve, port throttles 34 should be employed to minimize engine motoring torque. However, in some configurations it may be possible to use phasers on both camshafts, so as to permit greater flexibility in the controlling of valve timing and thus avoid any need for port throttles 34.

In FIG. 4, exhaust valve 54 is shown as opening and closing approximately symmetrically about bottom dead center (BDC) of the expansion stroke of a particular cylinder of engine 14, while intake valve 50 is shown as opening and closing approximately symmetrically about bottom dead center (BDC) of the intake stroke. As a result, atmospheric pressure is maintained for most of the cycle, as gases are pulled in an out through the open intake or exhaust valves. Near each TDC the intake and exhaust valves are both closed and pressure builds up, but the net effect is that the work required to compress the gases within the cylinder is extracted during expansion, and very little energy is dissipated within the engine cylinder.

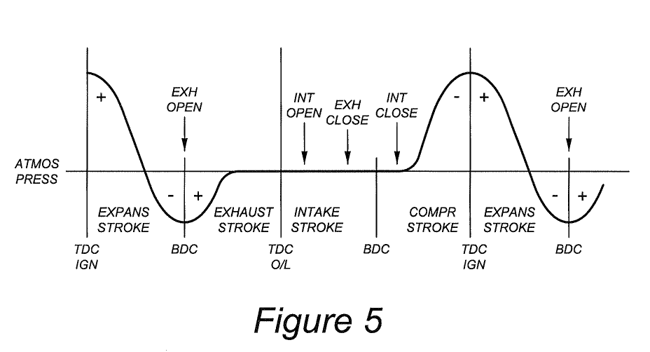

With some engines, such as single overhead cam (SOHC) or so-called OHV engines having valves actuated by pushrods, it may not be feasible to control exhaust cam phasing separately from intake cam phasing, as described in connection with FIGS. 3 and 4. In such case, engine motoring torque may be minimized by phasing intake and exhaust events equally. In FIG. 5, intake valve 50 is sown as opening and closing approximately symmetrically about bottom dead center (BDC) of the intake stroke, similarly to FIG. 4. Without separate control, the exhaust opening and closing are not symmetric about TDC or BDC, and negative work at the end of the expansion stroke is only partially recovered during the beginning of the exhaust stroke. Accordingly, the method of FIG. 5 is not as efficient as the methods of FIGS. 3 and 4. However, this method is more efficient than use of an unmodified engine, and has the added advantage of being less expensive and more feasible to implement than the other illustrated methods.

Those skilled in the art will appreciate in view of this disclosure that a variety of camshaft phaser mechanisms could be employed for the purpose of providing camshaft phaser 38. For example, U.S. Pat. No. 5,107,804 discloses a camshaft phaser mechanism suitable for use according to an aspect of the present invention.

During regenerative braking, controller 30 operates camshaft phaser 38 and port throttles 34, if engine 14 optionally includes the port throttles, so as to minimize the power required to motor engine 14, either by changing the exhaust valve phasing while closing port throttles 34 in the embodiment of FIG. 3, or alternatively, by changing both the intake valve and exhaust valve phasing in the manner shown in FIGS. 4 and 5. In this manner, because engine 14 is more easily motored, or rotated, by road wheels 12 motor/generator 18, less energy is lost to motoring friction and concomitantly more of the kinetic energy in vehicle 10 may be captured within traction battery 26 by operating motor/generator 18 as a generator.

Although the present invention has been described in connection with particular embodiments thereof, it is to be understood that various modifications, alterations, and adaptations may be made by those skilled in the art without departing from the spirit and scope of the invention set forth in the following claims.

What is claimed is:

1. A hybrid vehicle, comprising:
a reciprocating internal combustion engine having a crankshaft and a plurality of power cylinders, with each cylinder having a piston reciprocably housed therein;
at least one intake poppet valve and at least one exhaust poppet valve for each engine cylinder;
a transmission, coupled to said engine, with said transmission being connected to at least one roadwheel;
a rotating reversible machine, operatively connected with said transmission and said engine, as well as with an energy storage device, for providing power to said vehicle and for regeneratively charging said traction battery during braking of the vehicle; and
an engine controller for disabling at least some of said power cylinders during regenerative braking of said vehicle, by operating at least some of said poppet valves such that the poppet valves open and close at points which are approximately symmetrical about rotational positions of the crankshaft at which the directions of motion of said pistons change.

2. A hybrid vehicle according to claim 1, further comprising a plurality of intake port throttles, with one of said throttles mounted in proximity to each of said intake valves, wherein said engine controller closes the port throttles of the cylinders being disabled, while causing said exhaust poppet valves to open and close at points which are approximately symmetrical about said rotational crankshaft positions at which the directions of motion of the pistons change.

3. A hybrid vehicle according to claim 1, wherein said engine controller operates the intake valves of the cylinders being disabled such that the intake valves open and close at points which are symmetrical about rotational positions of the crankshaft at which the directions of motion of each of said pistons change.

4. A hybrid vehicle according to claim 1, wherein said engine controller operates the exhaust valves of the cylinders being disabled such that the exhaust valves open and close at points which are symmetrical about rotational positions of the crankshaft at which the directions of motion of each of said pistons change.

5. A hybrid vehicle according to claim 1, wherein each of said poppet valves is operated by a camshaft, and said controller further comprises a cam phaser for powering the camshaft and for adjusting the rotational position of the camshaft with respect to the engine's crankshaft.

6. A hybrid vehicle according to claim 1, wherein each of said intake poppet valves is operated by a first camshaft, and each of said exhaust poppet valves is operated by a second camshaft, and said controller further comprises a first cam phaser for powering said first camshaft and for adjusting the rotational position of the first camshaft with respect to the engine's crankshaft, and a second cam phaser for powering said second camshaft and for adjusting the rotational position of the second camshaft with respect to the engine's crankshaft.

7. A hybrid vehicle according to claim 1, wherein said rotating reversible machine is coupled to said transmission through said engine.

8. A hybrid vehicle according to claim 1, wherein said rotating reversible machine is coupled to said transmission through said engine at a fixed gear ratio.

9. A hybrid vehicle according to claim 1, wherein each of said power cylinders is disabled during regenerative braking.

10. A hybrid vehicle according to claim 1, wherein said rotating reversible machine comprises an electric motor/generator.

11. A hybrid vehicle according to claim 1, wherein said rotating reversible machine comprises a hydraulic motor/pump.

12. A hybrid vehicle according to claim 1, wherein said rotating reversible machine comprises a pneumatic motor/compressor.

13. A method for operating a reciprocating internal combustion engine in a hybrid vehicle during regenerative braking of the vehicle, comprising:
operating a rotating reversible machine, coupled to the engine and to at least one roadwheel through a transmission, as a power absorber; and
operating intake and exhaust poppet valves associated with the power cylinders of said engine such that said valves open and close at points which are approximately symmetrical about rotational positions of the engine's crankshaft at which the directions of motion of the engine's pistons change, whereby the power required to motor the engine during said regenerative braking will be minimized.

14. A method for motoring a reciprocating internal combustion engine in a hybrid vehicle during regenerative braking, such that the power required to motor the engine is reduced and regeneration is maximized, comprising:
operating a rotating reversible machine, coupled to at least one roadwheel and to said engine, as a generator connected to an energy storage device; and
disabling each of the power cylinders in the engine by operating intake and exhaust poppet valves associated with the power cylinders such that said valves open and close at points which are approximately symmetrical about rotational positions of the engine's crankshaft at which the directions of motion of the engine's pistons change.
